(19) United States
(12) Patent Application Publication
(10) Pub. No.: US 2019/0316947 A1
(43) Pub. Date: Oct. 17, 2019

(54) LONG PAIRED MEASURING SPOON SET

(71) Applicants: Devin G. Samuelson, Greenacres, WA (US); Cori Wright, Spokane Valley, WA (US)

(72) Inventors: Devin G. Samuelson, Greenacres, WA (US); Cori Wright, Spokane Valley, WA (US)

(21) Appl. No.: 15/953,323

(22) Filed: Apr. 13, 2018

(51) Int. Cl. G01F 19/00

(52) U.S. Cl. CPC G01F 19/002

(57) ABSTRACT

Three double ended measuring spoons making up a set of six measurements having a handle between each concave measurement end that adjoins them, making it easy to reach into the bottom of a deep container, at least 8 and 1/2 inches while holding on to the adjacent spoon opposite on the handle. In addition, the long handle in between the two dish like spoons has a magnet that holds multiple spoon sets together making it convenient to locate them all when they are not in use, are being stored, and ensuring that they are nested together so that the risk of them being separated and lost is mitigated.

### FIELD OF THE INVENTION

The present invention relates to measuring spoons and, more particularly, to their functional length and configuration which provides for a long handle to reach into deep containers while providing for a compact collected assembly for storage

### BACKGROUND OF THE INVENTION

The spice trade developed throughout South Asia and Middle East by as early as 2000 BCE with cinnamon and black pepper, and in East Asia with herbs and pepper. The Egyptians used herbs for mummification and their demand for exotic spices and herbs helped stimulate world trade.

This world trade of newfound pleasure of variety created an insatiable desire to acquire spices and herbs which spread across the globe. By 1000 BCE, medical systems based upon herbs could be found in China, Korea, and India. Early uses were connected with magic, medicine, religion, tradition, and preservation. This scarcity of global availability of spices, combined with the growing interest in spices resulted in spices becoming among the most demanded and expensive products available in Europe in the Middle Ages. This demand created the need for packaging into small quantities.

Spices were all imported from plantations in Asia and Africa, which made them expensive. From the 8th until the 15th century, the Republic of Venice had the monopoly on spice trade with the Middle East, and along with it the neighboring Italian maritime republics and city-states. It has been estimated that around 1,000 tons of pepper and 1,000 tons of the other common spices were imported into Western Europe each year during the Late Middle Ages. The value of these goods was the equivalent of a yearly supply of grain for 1.5 million people.

A little more than a century ago, the modernization and industrialization age began to improve global markets and commerce. Today, another expansion of global commerce is occurring with the availability of spices and herbs made readily available not just to the aristocrats, but to every one through e-commerce. Warehouse retailers such as Walmart, Costco, Sam's Club, and Amazon now deliver bulk products to consumers in many countries throughout the world at lower prices, and in larger quantity than ever before available.

With this increased availability of spices and herbs at lower cost, the storage containers found in cupboards are now larger and store more. However, with this increase of size in spice containers, the typical measuring spoons used to retrieve those spices do not accommodate that task without the need to dump the spice from the container, creating spillage and waste. Measurement spoons have long been used for retrieving spices from a small container.

The problem today is that long handled measuring spoons are absent from the consumer market place. Another problem with all measuring spoons to be dealt with is where and how to store them. With so many new gadgets and devices available today, kitchen drawer space is like prime real-estate. Many measuring spoons have rings that hold them together to address this problem of losing one of the spoons used for measurement. The rings become cumbersome to latch and unlatch to remove the individual measuring spoon needed. Often they are washed as an entire set, because of the inefficiency of taking them off of their holding ring. Some other measuring cups or measuring spoons have been designed with bosses and grooves on handles so that they can fit together, and snap to remain together during storage. These means of connecting them together wear out quickly, and soon the different sized measurement utensils become separated and even lost.

Measurement spoons that are less than six inches long are readily available in today's markets. Chemical supply houses have produced metal spoons which have a brazed cup attached to a handle that is as long as 8 to 10 inches. Some measurement spoons with long handles only have been made from metal in an attempt to solve this problem of working with dry goods and liquids which are stored in deep containers, however, they are bulky, heavy, and do not store well. Plastic thermoplastics have been used in injection molds to produce short spoons.

The cost to produce sheet metal measurement cups or spoons is significantly higher than that of plastic injection molding them. In the case where a cup and handle are brazed together, the heat affected zone of the braze creates a weakening of the metal, making it subject to breaking in those locations. In addition to this, the added step of brazing or welding in the production process is costly. Metal casting would be a method of production that would be sound, but has costly molds, and produces a heavy metal utensil that would be ergonomically less effective, and more difficult to store due to its weight.

The cost to produce a plastic injection molded item is significantly less that casting a metal item. However, the length of a plastic spoon handle of a typical design today does not have the rigidity necessary to support the loads of operation applied by users scooping up powders or other substances. Therefore, the shorter length handle has been typical of the configuration for most measuring cups and spoons. These handles are too short for deep containers. Another shortcoming of other designs is the method of unifying a set to keep track of the separate spoons when they are not in use.

The key-ring holders of measuring cups or measuring spoons are effective at keeping the various sizes together for storage, but make it more difficult to use the individual spoons or cups. When an individual measuring utensil is desired to be used, one must remove it from the ring. Most often, users keep all measuring devices on the ring and use the one, forcing the inefficient need to wash all of them when only one has been used, while others resort to removing the ring and disposing of it all together.

### SUMMARY OF THE INVENTION

In accordance with the present invention, there is provided three double ended, or paired, measuring spoons making up a set of six measurements having a long handle between each semi-concave measurement end that adjoins them, making it easy to reach into the bottom of a deep container, at least 8 and ½ inches while holding on to the adjacent spoon opposite on the handle. In addition, the long handle in between the two dish like spoons has a magnet that holds multiple spoon sets together making it convenient to locate them all when they are not in use, are being stored, and ensuring that they are nested together so that the risk of them being separated and lost is mitigated.

It would be advantageous to provide a measuring spoon that has a handle with a length sufficient to reach into the bottom of a spice container

It would also be advantageous to provide a measuring spoon that is strong enough to allow for for scooping forces which do not cause fractures or yield failures of the spoon or handle

It would further be advantageous to provide a nesting shape that allows the spoons to stack together

It is an object of the spoon set to store easily being held together with a magnet when not in use, or to be stored as a set on a ferrite metal surface

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top perspective view of a set of long handled double ended, nested or stacking measuring spoons for the purpose of measuring precise amounts of dry powders or liquids; and

FIG. 2 is a right section view of a structural channel handle adjoining two measurement scoop ends.

For purposes of clarity and brevity, like elements and components will bear the same designations and numbering throughout the Figures.

### DESCRIPTION OF THE PREFERRED EMBODIMENT

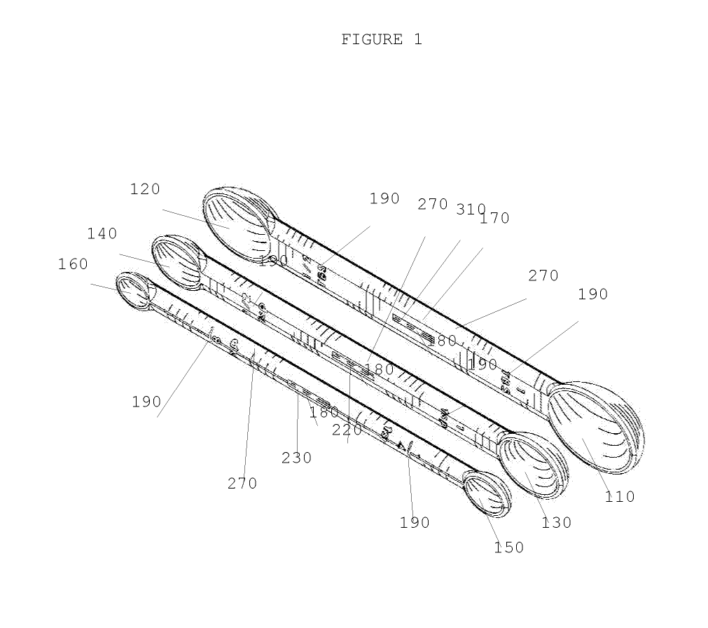

FIG. 1 is a top perspective view of a set of long handled double ended measuring spoons.

The double ended measuring spoon is comprised of a long handled structural beam support web 250 which is made from a thermoplastic material, and typically injection molded. The injection molding process is most efficient when a uniform wall thickness 260 is achieved. Each of the three measuring spoon pairs consists of two semi-spherical shaped scoop 240 ends which are connected by a structural beam support. The 1 tablespoon measurement scoop 110 is on one end of the measuring spoon pair while the ½ tablespoon measurement scoop 120 is on the other end of the spoon pair. The ½ teaspoon measurement scoop 140 is on one end of a pair with a structural beam support in the middle and the 1 teaspoon measurement scoop 130 is on the other end. A ¼ teaspoon measurement scoop 150 is on one end of a third measuring spoon pair while a ⅛ teaspoon measurement scoop 160 is on the other end of the third tool of the entire set. The three paired tools make up a complete set of six measurement sizes with three paired tools magnetically held together. The neodymium magnet 180 is permanently positioned into the handle, and is used to keep the pairs together as a single set, connecting magnetically to the medium handle neodymium magnet 220, which is connected magnetically to the small handle neodymium magnet 230. The three pairs make up a set.

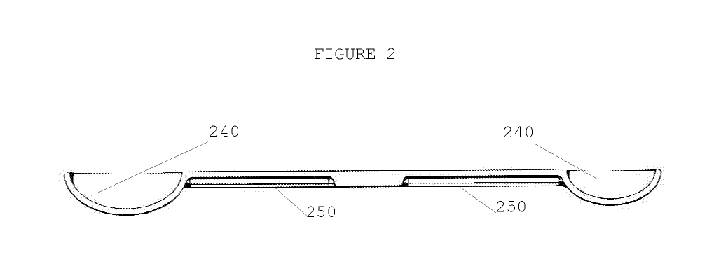

FIG. 2 contains a right section view of the structural channel handle adjoining two measurement scoop ends.

The structural channel is significant because this is what enables the tool to withstand appropriate loads such as those created by a moment of inertia at the spherical ends; adjoining long handle 170, the teaspoon adjoining long handle 200, and the ¼ teaspoon adjoining long handle 210.

The measuring volume label 190 is provided for on each handle and adjacent to the scoop end of the measuring spoon.

FIG. 2 is a right section view of a pair of measuring spoons illustrating the semi-spherical shaped scoop 240 on each end, adding to the overall length of the handle, and made rigid with a structural channel handle adjoining two measurement scoop ends. Each of the pairs of measuring spoons can be retained together by magnetically nesting as a result of the small handle neodymium magnet 230, the medium handle neodymium magnet 220, and the largest handle neodymium magnet 180.

In operation, the long handled measuring spoon can be held on one end, while the structural beam support web 250 provides operational rigidity to enable the semi-spherical shaped scoop 240 found on either end to be used to scoop up wet or dry substance such as powders or baking goods. With the extended length created having strong integrity due to the structural beam support web 250, and the uniform wall thickness 260, making ease of plastic injection molding efficient, the long handled measuring spoon is able to reach deep into bulk sized containers of spices or herbs, among other dry or wet substances, to remove precise quantities for use. The scoop can manage the load of dry or wet goods which are scaled to the volume of the measuring spoon.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A long paired measuring spoon set for reaching deep into containers to collect and dispense precise amounts of dry ground spices, powders, or liquids, comprising:
means for the purpose of making three pairs of measuring spoons forming a set of six measurement volumes;
means for the purpose of connecting two different sized measuring scoops a distance of at least 8 ½ inches between semi-spherical centers to create a rigid extra-long handle which can reach into deep containers;
means for the purpose is to magnetically holding spoons together when they are not in use and are in a nested position for storage, insertably connected to said means for the purpose of connecting two different sized measuring scoops a distance of at least 8 ½ inches between semi-spherical centers to create a rigid extra-long handle which can reach into deep containers;
means for the purpose of making a long handle that attaches two semi-spherical measurement scoops such as a 1 teaspoon and a ½ teaspoon scoop together, making it possible to reach into deep spice or herb containers, insertably connected to said means for the purpose is to magnetically holding spoons together when they are not in use and are in a nested position for storage;
means for the purpose of extending the reach and connecting the ¼ teaspoon and ⅛ teaspoon semi-spherical measuring scoops, insertably connected to said means for the purpose is to magnetically holding spoons together when they are not in use and are in a nested position for storage;
means for the purpose of extending the reach by connecting the 1 tablespoon to the ½ tablespoon semi-spherical measurement scoops into a pair;
means for the purpose of enabling magnetic nesting to other paired spoons in the set, magnetically connected to said means for the purpose of extending the reach by connecting the 1 tablespoon to the ½ tablespoon semi-spherical measurement scoops into a pair;
means for the purpose of collecting powder or liquid per a defined volume;
means for the purpose of reinforcing the long handle of a measuring tool such that it prevents plastic deformation and limits elastic deformation of the pair of measurement spoons;
means for the purpose of ensuring proper flow in a plastic injection mold system of manufacturing, uniformly constructed to said means for the purpose of reinforcing the long handle of a measuring tool such that it prevents plastic deformation and limits elastic deformation of the pair of measurement spoons, and insertably connected to said means for the purpose is to magnetically holding spoons together when they are not in use and are in a nested position for storage; and
means for the purpose of holding pairs of spoons together, magnetically connected to said means for the purpose of extending the reach by connecting the 1 tablespoon to the ½ tablespoon semi-spherical measurement scoops into a pair.

2. The long paired measuring spoon set in accordance with claim 1, wherein said means for the purpose of making three pairs of measuring spoons forming a set of six measurement volumes comprises a long handled set of measuring spoons.

3. The long paired measuring spoon set in accordance with claim 1, wherein said means for the purpose of connecting two different sized measuring scoops a distance of at least 8 ½ inches between semi-spherical centers to create a rigid extra-long handle which can reach into deep containers comprises a thermoplastic adjoining long handle.

4. The long paired measuring spoon set in accordance with claim 1, wherein said means for the purpose is to magnetically holding spoons together when they are not in use and are in a nested position for storage comprises a new attribute 1 neodymium magnet.

5. The long paired measuring spoon set in accordance with claim 1, wherein said means for the purpose of making a long handle that attaches two semi-spherical measurement scoops such as a 1 teaspoon and a ½ teaspoon scoop together, making it possible to reach into deep spice or herb containers comprises a teaspoon adjoining long handle.

6. The long paired measuring spoon set in accordance with claim 1, wherein said means for the purpose of extending the reach and connecting the ¼ teaspoon and ⅛ teaspoon semi-spherical measuring scoops comprises a ¼ teaspoon adjoining long handle.

7. The long paired measuring spoon set in accordance with claim 1, wherein said means for the purpose of extending the reach by connecting the 1 tablespoon to the ½ tablespoon semi-spherical measurement scoops into a pair comprises a medium handle neodymium magnet.

8. The long paired measuring spoon set in accordance with claim 1, wherein said means for the purpose of enabling magnetic nesting to other paired spoons in the set comprises a small handle neodymium magnet.

9. The long paired measuring spoon set in accordance with claim 1, wherein said means for the purpose of collecting powder or liquid per a defined volume comprises a new attribute 1 semi-spherical shaped scoop.

10. The long paired measuring spoon set in accordance with claim 1, wherein said means for the purpose of reinforcing the long handle of a measuring tool such that it prevents plastic deformation and limits elastic deformation of the pair of measurement spoons comprises a thermoplastic 0.080 to 0.120 thick structural beam support web.

11. The long paired measuring spoon set in accordance with claim 1, wherein said means for the purpose of ensuring proper flow in a plastic injection mold system of manufacturing comprises a thermoplastic uniform wall thickness.

12. The long paired measuring spoon set in accordance with claim 1, wherein said means for the purpose of holding pairs of spoons together comprises a long handle neodymium magnet.

13. A long paired measuring spoon set for reaching deep into containers to collect and dispense precise amounts of dry ground spices, powders, or liquids, comprising:
a long handled set of measuring spoons, for the purpose of making three pairs of measuring spoons forming a set of six measurement volumes;
a thermoplastic adjoining long handle, for the purpose of connecting two different sized measuring scoops a distance of at least 8 ½ inches between semi-spherical centers to create a rigid extra-long handle which can reach into deep containers;
a new attribute 1 neodymium magnet, for the purpose is to magnetically holding spoons together when they are not in use and are in a nested position for storage, insertably connected to said adjoining long handle;
a teaspoon adjoining long handle, for the purpose of making a long handle that attaches two semi-spherical measurement scoops such as a 1 teaspoon and a ½ teaspoon scoop together, making it possible to reach into deep spice or herb containers, insertably connected to said neodymium magnet;
a ¼ teaspoon adjoining long handle, for the purpose of extending the reach and connecting the ¼ teaspoon and ⅛ teaspoon semi-spherical measuring scoops, insertably connected to said neodymium magnet;
a medium handle neodymium magnet, for the purpose of extending the reach by connecting the 1 tablespoon to the ½ tablespoon semi-spherical measurement scoops into a pair;
a small handle neodymium magnet, for the purpose of enabling magnetic nesting to other paired spoons in the set, magnetically connected to said medium handle neodymium magnet;
a new attribute 1 semi-spherical shaped scoop, for the purpose of collecting powder or liquid per a defined volume;
a thermoplastic 0.080 to 0.120 thick structural beam support web, for the purpose of reinforcing the long handle of a measuring tool such that it prevents plastic deformation and limits elastic deformation of the pair of measurement spoons;
a thermoplastic uniform wall thickness, for the purpose of ensuring proper flow in a plastic injection mold system of manufacturing, uniformly constructed to said structural beam support web, and insertably connected to said neodymium magnet; and
a long handle neodymium magnet, for the purpose of holding pairs of spoons together, magnetically connected to said medium handle neodymium magnet.
